(19) United States
(12) Patent Application Publication
(10) Pub. No.: US 2009/0123117 A1
(43) Pub. Date: May 14, 2009

(54) Optical fiber connector with improved fastening member

(75) Inventors: Xin-wen Wang, Kunshan (CN); Zhong-Hua Yao, Kunshan (CN); Qi-Sheng Zheng, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 12/291,412

(22) Filed: Nov. 10, 2008

(30) Foreign Application Priority Data
Nov. 9, 2007 (CN) 200720042133.0

(51) Int. Cl. G02B 6/36

(52) U.S. Cl. 385/92

(57) ABSTRACT

An optical fiber connector (100) includes an insulative housing (1) defining a receiving chamber (170), an optical fiber member (2) received in the receiving chamber (170) and a fastening member (5) fixed to the insulative housing (1). The insulative housing defines a receiving space (16) communicating with the receiving chamber (170) and a protrusion (173) protruding into the receiving space (16). The fastening member (5) includes a main portion (50) covering the optical fiber member (2), an extension (51) extending from the main portion (50) for being fastened to the insulative housing, and an elastic arm (53) located below the extension (51). The elastic arm (53) has a hook (530) on a distal end thereof to flexible abut against the protrusion (173).

### BACKGROUND OF THE INVENTION

1. Field of the Invention

The present invention relates to an optical fiber connector, and more particularly to an optical fiber connector with improved fastening member and for being stably mounted to a Printed Circuit Board (PCB).

2. Description of Related Art

Present day telecommunication technology utilizes, to an increasing extent, optical fibers for signal transmission. The use of optical fibers, in turn, requires numerous collateral components especially adapted to handle the light or optical transmissions, among which are optical fiber connectors.

Optical fiber connectors for making connections between digital audio systems normally mate with a ferrule on a terminating end of the fiber. The ferrule is for alignment and support of the fiber made from glass or plastic. The ferrule is inserted into a receiving hole of a housing of the optical fiber connector. Examples of optical fiber connector that connects with a plastic fiber terminated in a ferrule include: i) the F07 Duplex Plastic Fiber System from AMP; ii) the SMI (small Muti-media Interface) Connector from Sony Corporation; and iii) the HFBR series of plastic fiber connectors from Hewlett Packard. To ensure performance of the optical connector, a door need to be provided to prevent dust and vapor in the air from entering the receiving hole of the housing.

U.S. Pat. No. 6,905,254 B2, issued on Jun. 14, 2005, discloses such an optical fiber connector which comprises an insulative housing, an insert body received in the insulative housing, a door member rotatably mounted in the insert body, an optical element received in the insulative housing and shielded by the door member, and a spacer fixed to the insulative housing. The insulative housing and the spacer includes mateable keys so that they can be fixed together. However, the mateable keys are both rigid as a result that the keys may suffer great engaging force, which can result in damage of the insulative housing. Besides, the insulative housing and the spacer may become flexible after multiple use because of the rigid locking between the keys.

Hence, an improved optical fiber connector is desired to overcome the above problems.

### BRIEF SUMMARY OF THE INVENTION

It is an object of the present invention to provide an optical fiber connector with elastic fixation between an insulative housing and a fastening member for strong structure and easy assembly.

Another object of the present invention to provide an optical fiber connector for being stably mounted to a PCB.

In order to obtain the object above, an optical fiber connector includes an insulative housing defining a receiving chamber, an optical fiber member received in the receiving chamber, a door pivotably mounted in the insulative housing, an elastic spring abutting against the door, and a fastening member fixed to the insulative housing. The insulative housing defines a receiving space communicating with the receiving chamber and a protrusion protruding into the receiving space. The insulative housing further includes a mounting post extending beyond a rear side thereof for mounting the optical fiber connector to a PCB. The mounting post defines a through hole further extending through a front side of the insulative housing in condition that the through hole is located at corner location of the insulative housing. The optical fiber member includes an optical receiving portion and a plurality of contacts electrically connected with the optical receiving portion. The fastening member is received in the receiving space to abut against the optical receiving portion. The fastening member includes a main portion covering the optical receiving portion, an extension extending from the main portion, and an elastic arm located below the extension. The extension is fastened to the insulative housing. The elastic arm has a hook on a distal end thereof to flexible abut against the protrusion.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an optical fiber connector and a fiber plug detachable with each other;

FIG. 2 is another perspective view of the optical fiber connector and the fiber plug shown in FIG. 1, but viewed from another aspect;

FIG. 3 is a part exploded view of the optical fiber connector showing a door member and a metal shell disengaging from an insulative housing;

FIG. 4 is an exploded view of the optical fiber connector shown in FIG. 1;

FIG. 5 is another exploded view of the optical fiber connector shown in FIG. 4, while taken from another aspect;

FIG. 6 is a rear and perspective view of the insulative housing; and

FIG. 7 is an enlarged perspective of a fastening member shown in FIG. 4, but viewed from another aspect.

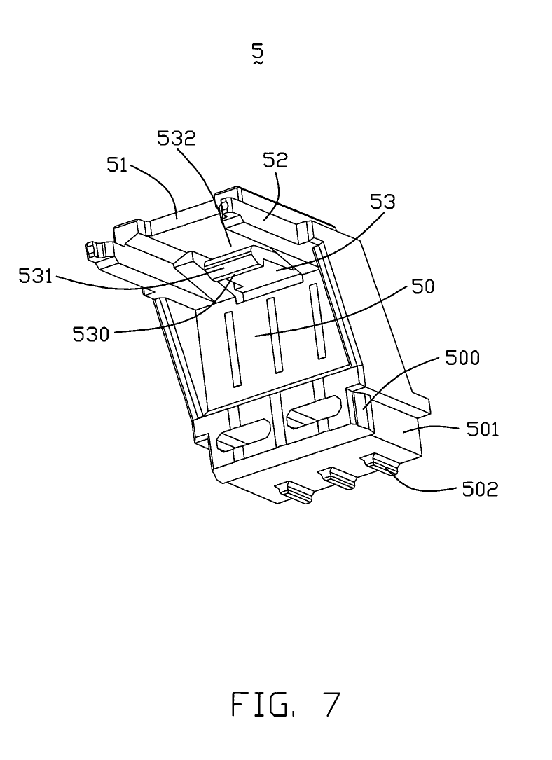

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

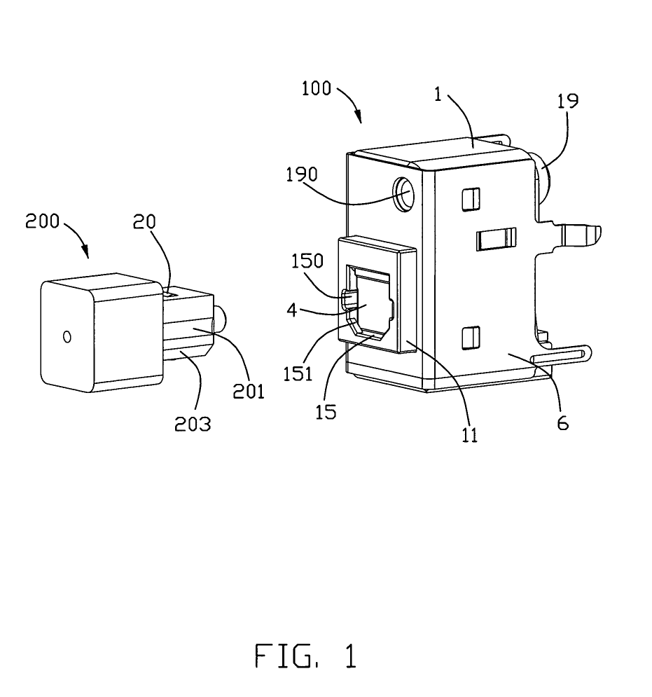

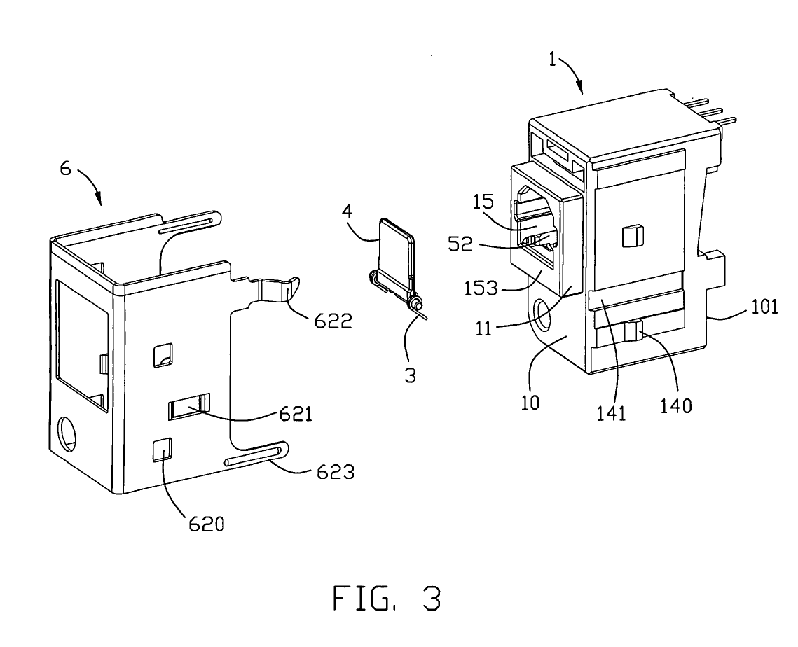

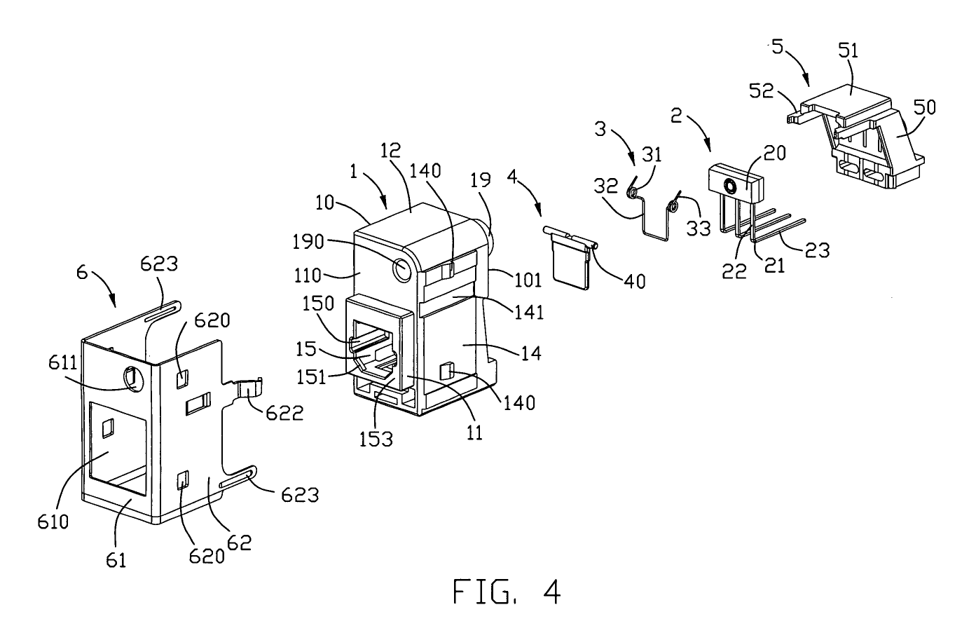

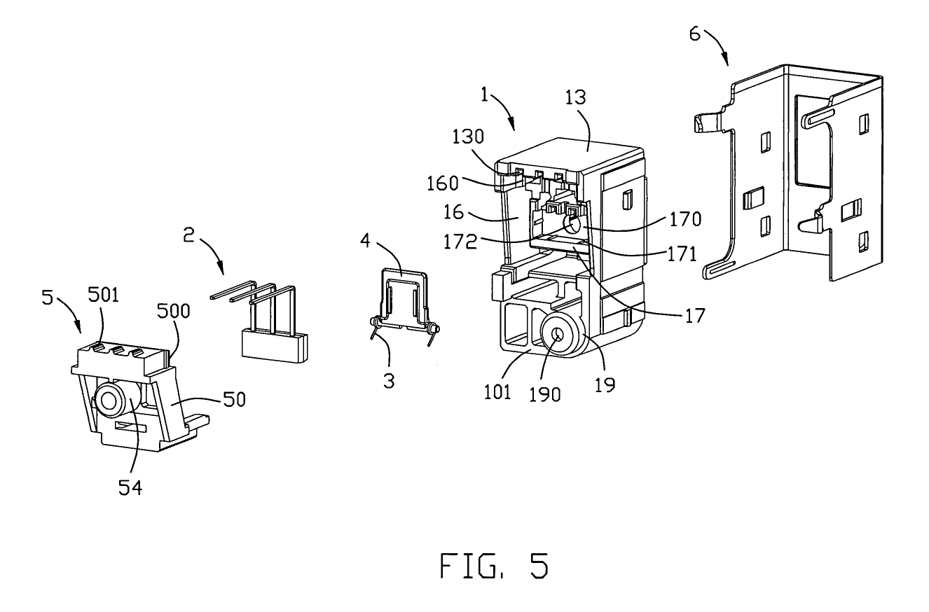

Referring to FIGS. 1-5, an optical fiber connector 100 for being mounted to a PCB (not shown) according to the preferred embodiment of the present invention includes an insulative housing 1, an optical fiber member 2 received in the insulative housing 1, a door 4 pivotably mounted to the insulative housing 1, an elastic spring 3 for abutting against the door 4, a fastening member 5 fixed to the insulative housing 1, and an outer metal shell 6 covering the insulative housing 1 for EMI protection.

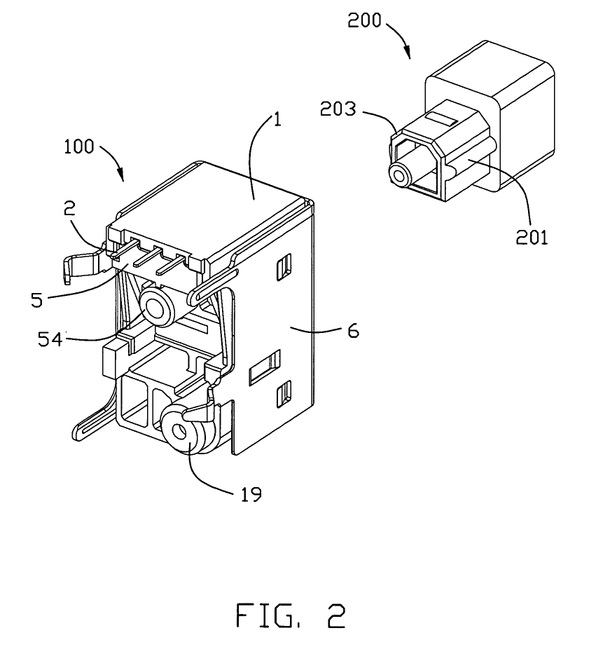

Referring to FIGS. 1-6, the insulative housing 1 includes a body 10 and a frame 11 integrally extending forwardly from a front surface 110 of the body 10. The body 10 includes a top wall 12, a bottom wall 13 and a pair of side walls 14 connecting the top and bottom walls 12, 13. A plug-receiving cavity 15 is recessed from a mating surface 153 of the frame 11 for receiving a fiber plug 200 as shown in FIGS. 1 and 2. The frame 11 includes a pair of rectangular recesses 150 on lateral sides thereof communicating with the cavity 15 for guiding insertion of the fiber plug 200. The body 10 includes a rear mounting surface 101 opposite to the front surface 110, and a receiving space 16 recessed from the rear mounting surface 101 for receiving the fastening member 5. As shown in FIG. 1, the frame 11 includes a pair of slant edges 151 at bottom lateral corners of the cavity 15 for preventing the door 4 from pivoting over outwardly from the cavity 15. The fiber plug 200 includes a mating section 20 which has a pair of arc ribs 201 on lateral sides thereof for mating with the recesses 150, and a pair of slant walls 203 for mating with the slant edges 151 of the frame 11 in order to assure right insertion of the fiber plug 200.

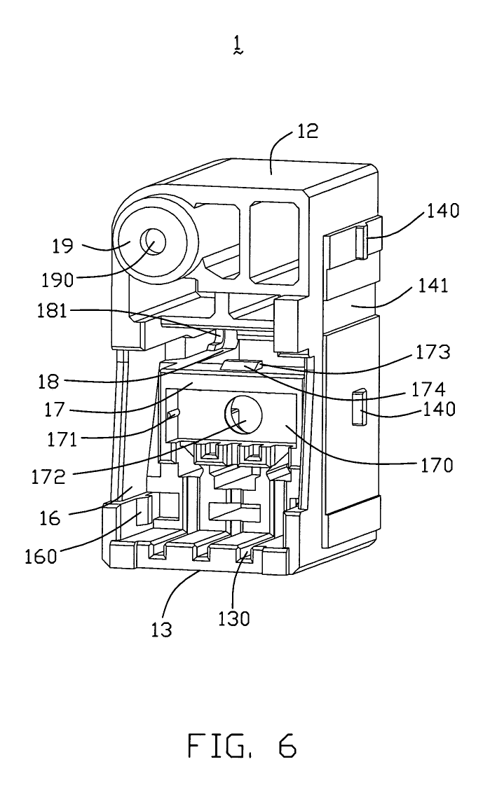

Referring to FIG. 6, the insulative housing 1 includes a pair of latches 160 sidewardly extending into the receiving space 16, a rectangular receiving chamber 170 communicating with the receiving space 16 for accommodating the optical fiber member 2, and a plate 17 located on top of the receiving chamber 170. The insulative housing 1 defines a slot 18 communicating with the receiving space 16 and a pair of cirque depressions 181 exposed to the slot 18. The cirque depressions 181 are adapted for receiving a pair of shafts 40 of the door 4 so that the shafts 40 can be rotatable in the depressions 181. The plate 17 includes a protrusion 173 extending into the receiving space 16 for abutting against the fastening member 5. The cavity 15 and the receiving chamber 170 are communicated with each other through a circle opening 172 which is designed for good radicalization of the optical fiber. The insulative housing 1 further includes a plurality of ribs 171 extending into the receiving chamber 170 for abutting against the optical fiber member 2 so that the optical fiber member 2 can be firmly fixed in the receiving chamber 170.

The insulative housing 1 includes a first column shaped mounting post 19 located on top and right corner thereof. A through hole 190 is recessed from the mounting post 19 and further extending through the front surface 110. Each side wall 14 includes a pair of protuberances 140 and a guiding recess 141 located between the protuberances 140. The bottom wall 13 defines a plurality of slits 130 communicating with the receiving space 16 for mating with the fastening member 5 which will be detailed hereinafter.

The optical fiber member 2 includes an optical receiving portion 20 received in the receiving chamber 170 and a plurality of contacts 21 electrically connected with the optical receiving portion 20. Each contact 21 includes a vertical portion 22 and a tail portion 23 perpendicular to the vertical portion 22.

The elastic spring 3 includes opposite circles 31, a U-shaped fixed portion 32 connecting the circles 31, and a pair of pressure portions 33 extending from the circles 31, respectively.

The fastening member 5 includes a slant-shaped main portion 50 and an extension 51 extending forwardly and horizontally from the main portion 50. The main portion 50 includes a pair of contractive projections 52 for being received in the slot 18 of the insulative housing 1 and a second column shaped mounting post 54. The pair of first and second mounting posts 19, 54 extend beyond the rear mounting surface 101 for corporately mounting the optical fiber connector 100 to the PCB. The fastening member 5 further includes a cantilevered elastic arm 53 located below the extension 51 and form a gap 532 between the elastic arm 53 and the extension 51. The gap 532 provides a space for deformation of the elastic arm 53 when the fastening member 5 is inserted into the receiving space 16. The elastic arm 53 is located between the pair of projections 52 and includes a hook 530 at a distal end thereof. The hook 530 and the protrusion 173 have mateable inclined surfaces 531, 174, respectively, so that the fastening member 5 can be easily inserted into the receiving space 16. The main portion 50 further includes a bottom section 501 which includes a pair of ribs 500 extending outwardly from opposite sides thereof and a plurality of blocks 502 protruding downwardly.

Regarding FIGS. 2-5, the metal shell 6 is stamped from an integral metal sheet and comprises a front wall 61, and a pair of side walls 62 extending backwardly from the front wall 61. The front wall 61 defines a rectangular opening 610 for the frame 11 of the insulative housing 1 extending therethrough, and a circle hole 611 corresponding to the through hole 190 of the insulative housing 1. Each side wall 62 includes a pair of holes 620 for mating with the protuberances 140, a boss 621 received in the guiding recess 141, and a pair of first and second retaining tabs 622, 623 for mounting the optical fiber connector 100 to the PCB.

In assembly, the opposite circles 31 of the elastic spring 3 are attached to the pair of shafts 40 of the door 4 to combine a door member which will be received in the cavity 15 through the slot 18. The optical receiving portion 20 is received in the receiving chamber 170. The tail portions 23 are located in the slits 130 and further extend beyond the rear mounting surface 101 to be soldered to the PCB. The fastening member 5 is inserted into the receiving space 16 with the inclined surfaces 531, 174 guiding each other. The elastic arm 53 deforms in the gap 532 and then abuts against the protrusion 173 so that the fastening member 5 can be flexibly fixed to the insulative housing 1. Besides, the latches 160 of the insulative housing 1 abut against the ribs 500 for further fixation. The blocks 502 are received in the slits 130 to press the tail portions 23. The metal shell 6 is fixed to the insulative housing 1. The circle hole 611 communicates with the through hole 190 of the insulative housing 1. When the optical fiber connector 100 is mounted to the PCB, the rear mounting surface 101 is attached to the PCB and the first and the second mounting posts 19, 54 are inserted into through holes (not shown) in the PCB. For more firmly assembly, a bolt (not shown) is fastened through the circle hole 611 and the through hole 190 to the insulative housing 1.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An optical fiber connector, comprising:
an insulative housing defining a receiving chamber, a receiving space communicating with the receiving chamber, and a protrusion protruding into the receiving space;
an optical fiber member received in the receiving chamber and including an optical receiving portion and a plurality of contacts electrically connected with the optical receiving portion; and
a fastening member received in the receiving space to abut against the optical receiving portion, the fastening member including a main portion covering the optical receiving portion, an extension extending from the main portion, and an elastic arm located below the extension, the extension being fastened to the insulative housing, the elastic arm having a hook on a distal end thereof to lock the protrusion in order to prevent the fastening member from falling off from the receiving space.

2. The optical fiber connector according to claim 1, wherein the insulative housing defines a slot communicating with the receiving space, the extension horizontally extending from the main portion and including a pair of projections received in the slot, the elastic arm being located between the pair of projections.

3. The optical fiber connector according to claim 1, wherein the elastic arm is cantileveredly located below the extension and defines a gap therebetween in order that the elastic arm can be deformable in the gap during insertion of the fastening member into the receiving space.

4. The optical fiber connector according to claim 1, wherein the hook and the protrusion include mateable inclined surfaces, respectively, for guiding insertion of the fastening member into the receiving space.

5. The optical fiber connector according to claim 1, wherein the main portion includes a bottom section opposite to the extension, the bottom section having a pair of ribs extending outwardly from opposite sides thereof, the insulative housing comprising a pair of latches extending into the receiving space to abut against said pair of ribs.

6. The optical fiber connector according to claim 5, wherein the insulative housing defines a plurality of slits communicating with the receiving space, the contacts having tail portions received in the slits, the bottom section further including a plurality of blocks received in the slits in order to press the tail portions.

7. The optical fiber connector according to claim 1, wherein the insulative housing includes at least one rib exposed to the receiving chamber to abut against the optical receiving portion.

8. The optical fiber connector according to claim 1, wherein the insulative housing includes a front surface and a mounting surface opposite to the front surface, the receiving chamber and the receiving space being both recessed from the mounting surface, the main portion including a mounting post for fixing the optical fiber connector to a PCB.

9. The optical fiber connector according to claim 8, wherein the insulative housing includes another mounting post located on a corner location thereof in condition that the pair of mounting posts extend beyond the mounting surface for corporately fixing the optical fiber connector to the PCB.

10. The optical fiber connector according to claim 1, wherein the insulative housing includes a frame extending beyond a front surface thereof, the frame defining a cavity communicating with the receiving chamber, the optical fiber connector further comprising a door pivotably mounted in the cavity for shielding or exposing the optical receiving portion, and an elastic spring abutting against the door.

11. An optical fiber connector for being mounted to a PCB, comprising:
an insulative housing defining a receiving room and a cavity recessed from front and rear sides of the insulative housing, respectively, the receiving room and the cavity communicating with each other;
an optical fiber member received in the receiving room and including an optical receiving portion and a plurality of contacts electrically connected with the optical receiving portion;
a door pivotably mounted in the cavity for shielding or exposing the optical receiving portion; and
an elastic spring abutting against the door;
wherein the insulative housing comprises a mounting post extending beyond the rear side for mounting the optical fiber connector to the PCB, the mounting post defining a through hole further extending through the front side in condition that the through hole is located at corner location of the insulative housing.

12. The optical fiber connector according to claim 11, wherein the receiving room and the cavity communicate with each other through a circle opening.

13. The optical fiber connector according to claim 11, further comprising a fastening member received in the receiving room to abut against the optical fiber member, the fastening member including a main portion covering the optical receiving portion and another mounting post extending beyond the main portion, the pair of mounting posts being adapted for corporately mounting the optical fiber connector to the PCB.

14. The optical fiber connector according to claim 13, wherein the fastening member comprises an extension extending from the main portion and an elastic arm located below the extension, the extension being fastened to the insulative housing, the elastic arm having a hook on a distal end thereof, the insulative housing including a protrusion protruding into the receiving room to abutting against the hook.

15. The optical fiber connector according to claim 14, wherein the elastic arm is cantileveredly located below the extension and defines a gap therebetween in order that the elastic arm can be deformable in the gap during insertion of the fastening member into the receiving room.

16. The optical fiber connector according to claim 14, wherein the hook and the protrusion include mateable inclined surfaces, respectively, for guiding insertion of the fastening member into the receiving room.

17. An optical fiber connector comprising:
an insulative housing defining a front mating face for mating a plug, and a rear mounting face for mounting to a printed circuit board, and a receiving cavity, for receiving said plug, rearawardly recessed from the front mating face;
an optical element located behind the receiving cavity; and
a fastening member located behind the optical element to cooperate with the housing for holding the optical element in position; wherein
a mounting post is unitarily formed with the housing and located at a corner at the housing with a through hole extending through both said front face and said rear face to allow a pole to extend therethrough for fastening the housing to the printed circuit board.

18. The optical fiber connector as claimed in claim 17, wherein said fastening member is configured to be only forwardly assembled to the housing.

19. The optical fiber connector as claimed in claim 18, wherein said fastening member is hidden within the housing after assembled.
